(19) United States
(12) Patent Application Publication
(10) Pub. No.: US 2021/0286161 A1
(43) Pub. Date: Sep. 16, 2021

(54) APPARATUSES AND METHODS FOR IMAGING INCOHERENTLY ILLUMINATED OBJECTS

(71) Applicant: The Government of the United States, as represented by the Secretary of the Navy, Washington, DC (US)

(72) Inventor: Dennis Gardner, Washington, DC (US)

(21) Appl. No.: 17/331,932

(22) Filed: May 27, 2021

Related U.S. Application Data
(63) Continuation of application No. PCT/US19/68684, filed on Dec. 27, 2019.
(60) Provisional application No. 62/785,305, filed on Dec. 27, 2018.

(51) Int. Cl. G02B 21/36; H04N 5/225; G02B 21/00

(52) U.S. Cl. CPC G02B 21/367; G02B 21/0032; H04N 5/2256

(57) ABSTRACT

Methods and apparatuses for imaging an incoherently illuminated object are provided. Image data recorded by an image detector is received. The image data comprises a plurality of images respectively corresponding to a plurality of scanning positions. Each image is produced in response to the image detector receiving incoherent light that has passed through an object and then been diffused by a scattering layer. A plurality of diffraction patterns respectively corresponding to the plurality of scanning positions are generated from the image data, and the image of the object is reconstructed based on the plurality of diffraction patterns and the plurality of scanning positions.

### BACKGROUND

### Field of the Invention

The present application relates generally to imaging incoherently illuminated objects.

### Description of Related Art

Most imaging systems use lenses. However, there are wavelength ranges where there is limited image forming hardware. To overcome this limitation, coherent lensless imaging techniques have been used such as coherent diffractive imaging (CDI). In CDI, the intensity of a diffraction pattern from a coherently illuminated object is recorded. The phase information is lost during the detection, but with iterative phase retrieval algorithms the phase can be recovered and the object reconstructed. In CDI, the maximum size of an object that can be imaged is limited by Nyquist sampling. To satisfy the sampling requirements, objects imaged using CDI are mostly opaque objects with a relatively small region of transmission.

An extension of CDI is ptychography. In ptychography, the illumination is constrained such that the illuminated area of the object satisfies Nyquist sampling requirements. To build up a larger field-of-view, either the illumination or object is scanned. At each scan position, the diffracted light is recorded. Typically, there is 60-70% overlap between scan positions. The set of diffraction patterns are used to reconstruct the image of the object. Compared to CDI, ptychography expands the types of objects that can be imaged, from isolated samples to extended objects, and has found applications in EUV, x-ray, and terahertz imaging. However, all of these techniques require the use of coherent light. It would be beneficial to have techniques that could image larger objects using incoherent light.

### SUMMARY OF THE INVENTION

One or more the above limitations may be diminished by structures and methods described herein.

In one embodiment, a method for imaging an incoherently illuminated object is provided. Image data recorded by an image detector is received. The image data comprises a plurality of images respectively corresponding to a plurality of scanning positions. Each image is produced in response to the image detector receiving incoherent light that has passed through an object and then been diffused by a scattering layer. A plurality of diffraction patterns respectively corresponding to the plurality of scanning positions are generated from the image data, and the image of the object is reconstructed based on the plurality of diffraction patterns and the plurality of scanning positions.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-F illustrate a system for imaging an object using incoherent light according to one embodiment.

FIG. 2A illustrates an optical beam impinging on an object to be imaged.

FIG. 2B illustrates a plurality of scanning positions overlaid on an object to be imaged.

FIG. 3 illustrates a method of imaging an object using an incoherent light source according to one embodiment.

FIG. 4 illustrates an autocorrelation frame corresponding to one scanning position.

FIG. 5 illustrates background information corresponding to one scanning position.

FIG. 6 illustrates a recovered diffraction pattern corresponding to one scanning position.

FIG. 7 illustrates a reconstructed image of an object produced according to one embodiment.

Different ones of the Figures may have at least some reference numerals that are the same in order to identify the same components, although a detailed description of each such component may not be provided below with respect to each Figure.

### DETAILED DESCRIPTION OF THE PREFERRED EMBODIMENTS

In accordance with example aspects described herein are methods and apparatuses for performing ptychographic imaging of incoherently illuminated objects.

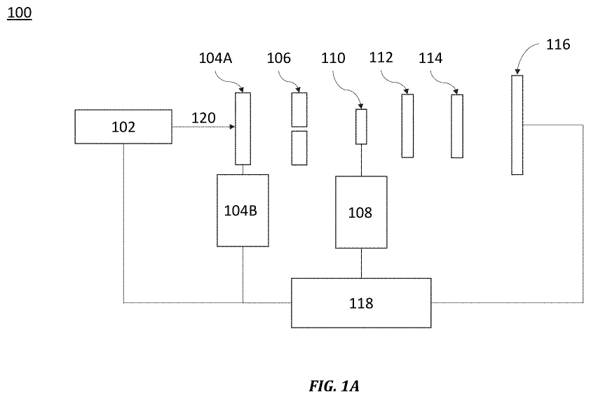

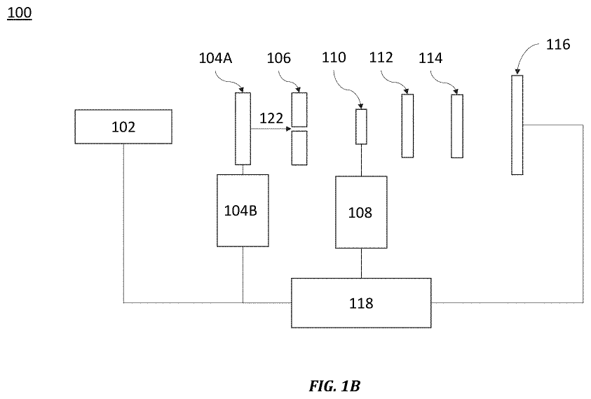

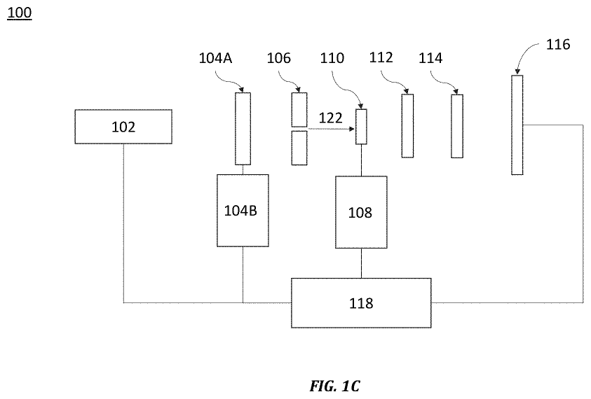

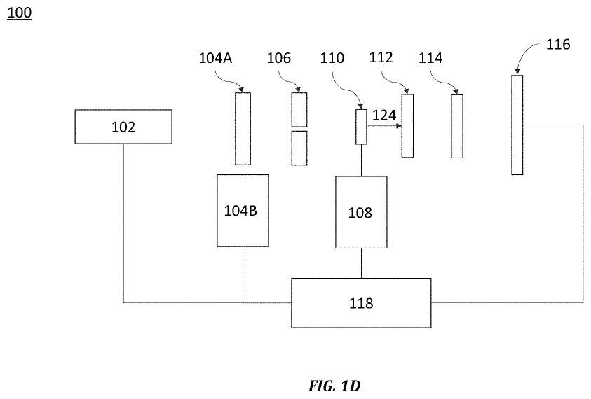

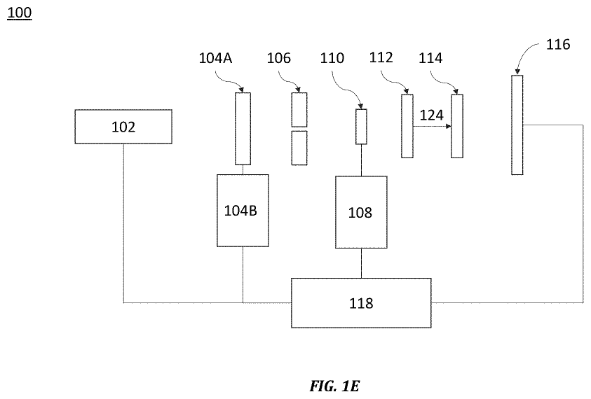

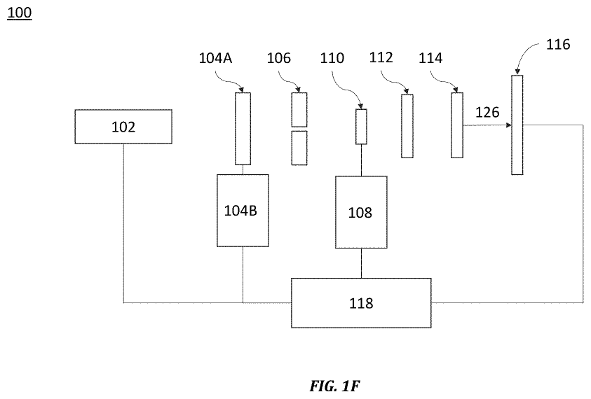

FIGS. 1A-F illustrate the overall arrangement of an exemplary system 100 for ptychographic imaging of incoherently illuminated extended objects. An optical source 102 is provided and configured to emit an optical beam 120. In one embodiment, the optical source 102 is a laser. One exemplary type of laser is a 5 mW HeNe laser that outputs an optical beam 120 with a wavelength of 632.8 nm. Of course, this is merely exemplary. Other lasers of different wavelengths may be used provided they are capable of being transmitted through the optical elements in system 100, described below. The optical beam 120 is provided to a diffuser 104A. In one embodiment, the diffuser 104A may is a 220 grit rotating ground glass diffuser. However, like with the optical source 102, other types of diffusers may be used. To control the rotation of the diffuser 104A, a stepper motor 104B is provided. The stepper motor 104B is controlled to rotate at a predetermined rate. In one embodiment, the predetermined rotation rate is 139 rpm. Once again, however, this is merely exemplary and other rotation rates may be used. The combination of the optical source 102 and the rotating diffuser 104A may be considered to be a pseudothermal source, i.e. a narrowband spatially-incoherent source. In an alternative embodiment, other incoherent optical sources may be used.

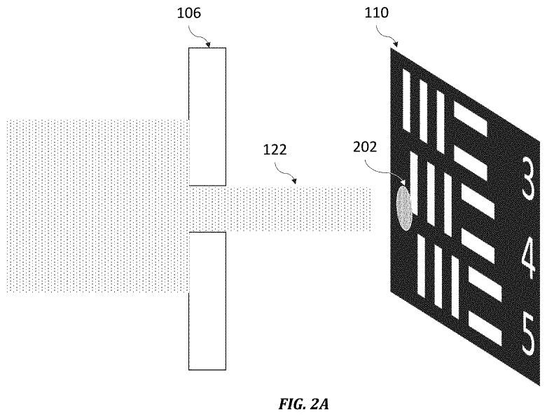

By passing through the rotating diffuser 104A, the optical beam 120 is transformed into an incoherent optical beam 122. The incoherent optical beam 122 is directed towards and through a pinhole 106. In an exemplary embodiment, the pinhole 106 is formed by pushing a pin through aluminum foil to form a hole that is approximately 690 microns in diameter. In an exemplary embodiment, pinhole 106 is placed 13 mm after the diffuser 104A. Of course, pinholes of different sizes and distances from the diffuser 104A may also be used provided that they limit the spatial extent of the illumination on object 110. After traversing through pinhole 106, the incoherent optical beam 122 illuminates an object 110. In an exemplary embodiment, object 110 is disposed 4 mm after pinhole 110. Again, this distance is merely exemplary. The impingement of optical beam 122 on object 110 results in a spot 202, as shown in FIG. 2A. As seen in FIG. 2A, the area of spot 202 is smaller than the area of object 110. As discussed below, object 110 is translated in two dimensions in order to raster spot 202 across the object 110. To accomplish that translation, object 110 is connected to a translator 108, which may be two linear translation stages. Object 110 is translated, in a preferred embodiment, in a plane that is perpendicular to the optical axis of optical beam 122, as described below.

A portion of the optical beam 122 passes through object 110 and is directed towards an iris 112. For convenience, the portion of the optical beam 122 that is transmitted through the object 110 is referred to as an image beam 124. The iris 112 controls the spatial extent of the image beam 124 on a scattering layer 114 disposed downstream of the iris 112 in the optical path. In an exemplary embodiment, the diameter of the iris is approximately 0.8 mm. The scattering layer 114 scatters the image beam 124 to form a scattered image beam 126. The scattering layer 114, in an exemplary embodiment, comprises a 120 grit ground glass diffuser which is stationary while the image detector 116 captures image data. Image detector 116 is constructed to receive the scattered image beam 126 and produce image data corresponding to the scattered image beam 126. In an exemplary embodiment, the image detector 116 is a CMOS image detector with 1280 by 1024 pixels with a bit depth of 10. The pixels are square with a side length of 5.2 microns. Of course, this particular image detector is merely exemplary and other CMOS image detectors could also be used. In addition, other types of image detectors (e.g., a CCD detector) could also be used. The distance from the object 110 to the scattering layer 114, in an exemplary embodiment, is 159.5 mm, and the distance from the scattering layer 114 to the image detector 116 is 45 mm resulting in a magnification of 0.282.

Finally, the image detector 116 is communicatively connected to controller 118. Controller 118 includes a processor, which may be a central processing unit, a microcontroller, or a microprocessor, and memory that stores a control program that, when executed, causes the controller 118 to control the optical source 102, stepper motor 104B, translator 108, and image detector 116 to operate as described herein. Controller 118 may also include software to perform the steps shown in FIG. 3 and described below. The memory is also configured to store data and instructions received from one or more of the optical source 102, stepper motor 104B, translator 108, and image detector 116. Controller 118 includes input/output circuitry and hardware that allows for communication with the optical source 102, stepper motor 104B, translator 108, and image detector 116. Such input/output circuitry may also provide for a connection with another external device (not shown) such as a USB device, memory card, or another computer. Having described the physical arrangement of system 100, attention will now be directed to image acquisition and data processing.

As described above, the area of spot 202 is less than the area of object 110. Thus, to image object 110 it is necessary to move object 110 using the translator 108 so as to raster spot 202 to a plurality of different scanning positions across object 110, as illustrated in FIG. 2B. FIG. 2B shows a test object 110. The test object 110 includes three numbers: “3”, “4”, and “5” which allow partial transmission of light. Adjacent to each of these numbers is a pattern that comprises three vertical lines and two horizontal lines which also allow partial transmission. Of courses, the surrounding areas may also allow varying degrees of partial transmission, complete transmission, or none at all. The patterns are horizontally offset with respect to each other. Of course, object 110 is merely exemplary and may be replaced with an object of interest. Also shown in FIG. 2B are scanning positions 204ᵢⱼ for the image beam 122. Scanning positions 204ᵢⱼ are arranged in an array where “i” designates a row and “j” designates a column. Thus, the scanning position at the top of left FIG. 2B would be 214₁₁.

FIG. 3 illustrates a method for reconstructing an image of object 110. In S302, image data of the object 110 is collected from the plurality of scanning positions 214ᵢⱼ. Controller 118 controls the translator 108 to move the object 110 such that a center of the optical beam 122 is located at one of the scanning positions 204ᵢⱼ. For example, if 214₁₁ is the first scanning position, controller 118 would provide instructions to translator 108 to move object 110 into a position where scanning position 204₁₁ is located approximately in a centroid of beam 122. An exposure is then recorded by image detector 116. In an exemplary embodiment, the length of the exposure is 300 ms. Of course, this time may vary depending on the type of detector used and the power of the optical source. Higher power optical sources will require lower exposure times and vice-versa. Controller 118 then controls translator 108 to move the object 110 such that a center of the optical beam 122 is located at a second scanning position of the scanning positions 204ᵢⱼ and another image is recorded. This process repeats until image data is acquired for all scanning positions 204ᵢⱼ. Thus, in the exemplary embodiment shown in FIG. 2B, 247 frames of image data are acquired respectively corresponding to the 247 scanning positions. In an exemplary embodiment, the scattering layer 114 may be rotated after image data from the plurality of scanning positions 204ᵢⱼ is acquired to get new independent speckle realizations. These independent realizations may be obtained by rotating the scattering layer 214 by an arc length that is longer than its diameter. In one embodiment, additional hardware under the control of controller 118 may be provided to effect this rotation. In a preferred embodiment, three independent speckle realizations may be obtained. The independent speckle realizations may be used to improve the quality of the calculated diffraction patterns, whose generation is discussed below.

Next, in S304, a plurality of diffraction patterns are generated. First, controller 118 generates an autocorrelation frame for each image frame based on image data from detector 116, as described below.

Aₙ=Iₙ*Iₙ=[(ψₙ*S)*(ψₙ*S)]=[(ψₙ*ψₙ)*(S*S)] Equation 1:

In Equation 1, above, Aₙ is an autocorrelation frame for an nth image, “*” is the autocorrelation operator, “*” is convolution operator, S represents a random speckle pattern from the scattering layer 114, and ψₙ is the exit surface intensity (ESI) of image beam 124 immediately after the object 110. If the extent of the illumination by image beam 124 on the scattering layer 114 is within the memory effect range, the intensity recorded by image detector 116 is given by Equation 2 below:

In(r)=ψₙ(r)*S(r) Equation 2:

In Equation 2, “r” is the real-space coordinate perpendicular to the optical axis for a given scanning position. Returning to Equation 1, if the geometry of system 100 allows for small speckles (but at least Nyquist sampled) then the autocorrelation of the random speckle patterns (S*S in Equation 1) is a strongly peaked function, like a delta function. This allows Equation 1 to be rewritten as shown below in Equation 3.

Aₙ=[ψₙ(r)*ψₙ(r)]+C(r) Equation 3:

In Equation 3, C(r) is a background from the S*S term and the envelope of the intensity on the detector 114. If one were to produce an image of the autocorrelation of a recorded frame, the ESI information would be located at the center of the autocorrelation and sits on top of the background. If one subtracts the background from Equation 3 and applies the autocorrelation theorem Equation 4, below, is arrived at:

ψₙ(u)=| [symbol] {ψₙ}|={square root over ( [symbol] {A_{n_NoBKG}})} Equation 4:

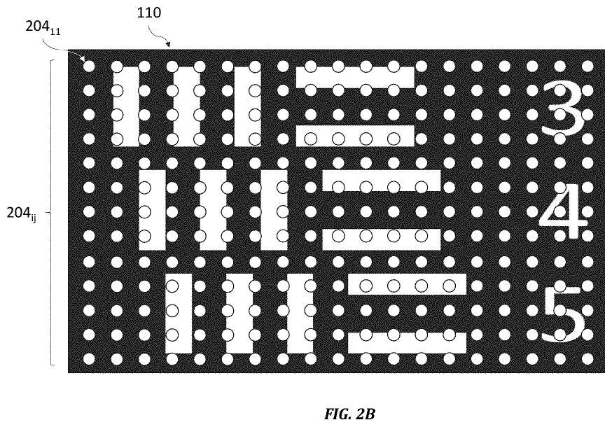

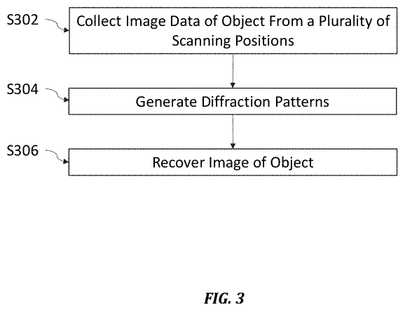

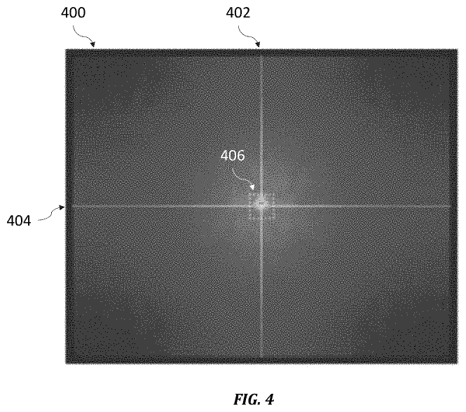

In Equation 4, [symbol] { } is the Fourier transform operator, the ∥ denote the absolute value, and A_{n_NoBKG} is the background subtracted autocorrelation, Ψ is the diffraction pattern of ψ and u is a spatial frequency coordinate. The different feature sizes and transmission values for object 110 at each scan location results in varying strengths of the autocorrelation peak to background ratio. To generate a fit of the background, a lineout cross-section is taken in the horizontal direction (404) and vertical direction (402) of each autocorrelation frame 400, as illustrated in FIG. 4. Lineouts 402 and 404 are then smoothed with a moving boxcar average of 5 pixels, in one embodiment, to produce smooth lineouts 402 and 404. The smooth lineouts are then fitted with a Fourier series fit that includes 8 cosine and 8 sine terms for amplitude terms, an offset term, and a frequency term, in an exemplary embodiment. A central region 406 of the autocorrelation frame is not included in the background calculation since it contains information to be extracted. The square root of the outer product is used to generate a two-dimensional background 500, as shown in FIG. 5.

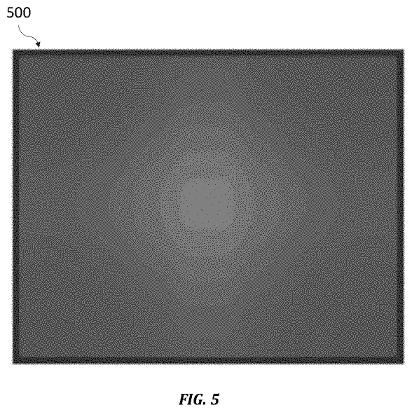

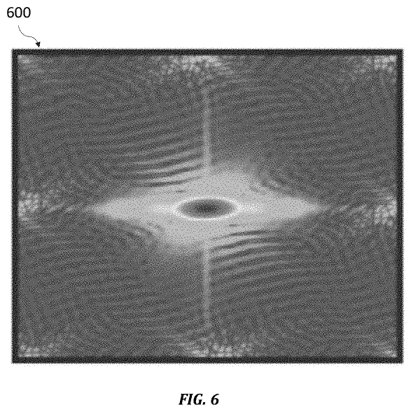

With the background information in hand, the background 500 is then subtracted from the autocorrelation frame 400. After the subtraction of the background 500, a tapered cosine window (Tukey window with a taper ratio of 0.5) is used to select the central region 406 of the autocorrelation frame 400 (which is now minus background 500). In an exemplary embodiment, a 2D window may be generated using the square root of the outer product of two 1D Tukey window, each 88 pixels in length. After the application of the window, a Fourier transform and square root is taken, respectively, of the central region 406. The result is the magnitude of the diffraction pattern of the ESI 600, as shown in FIG. 6. This process is repeated for each image frame based on the image data recorded by image detector 116. With this set of diffraction data for each scan position, an image of object 110 can now be reconstructed, as explained below.

Returning to FIG. 3, with the set for diffraction patterns obtained in S304, an image of object 110 can now be reconstructed. In an exemplary embodiment, a modified version of the extended Ptychographical Iterative Engine (ePIE) is used to reconstruct an image of object 110, as explained below. However, other ptychography algorithms may also be used including those by M. Guizar-Sicairos et al. described in “Phase retrieval with transverse translation diversity: a nonlinear optimization approach” published Opt. Express 16, 7264 (2008) and P. Thibault et al. described in “Probe retrieval in ptychographic coherent diffractive imaging” published in Ultramicroscopy 109, 338-343 (2009), the contents of both of these references are incorporated by reference herein in their entirety.

Returning to the modified version of ePIE mentioned above, reconstructing an image of object 110 according to this method begins with making a guess of the ESI, according to Equation 5 below:

ψ_{j,n}=O_{j,n}(r−Rₙ)P_{j,n}(r) Equation 5:

The current iteration is denoted by j and n is a scan position. When running the algorithm, the scanning positions 204ᵢⱼ are called in a random order. On the first iteration, the object (O) is unity (all ones) and illumination (P) is based on the size of the pinhole. The Fourier transform of ψ_{j,n} is calculated and the modulus constraint is applied, i.e. the recovered diffraction pattern from the intensity measurement (Equation 4 above) is enforced and the phase is kept:

$${Ψ}_{j , n} ( u ) = {Ψ}_{n} ( u ) \qquad Equation 6$$

After the modulus constraint, an updated ESI is calculated, according to Equation 7:

ψ′_{j,n}(r)= [symbol] ⁻¹{Ψ_{j,n}(u)} Equation7:

Now the object and the probe are updated according to Equations 8 and 9, respectively:

$$\begin{matrix}{O}_{j + 1 , n} = {O}_{j , n} + α \frac{{P}_{j , n}^{*} ( r + {R}_{n} )}{{\vert {P}_{j , n} ( r + {R}_{n} ) \vert}_{max}^{2}} ( {{ψ}^{′}}_{j , n} - {ψ}_{j , n} ) & Equation 8 \\ {P}_{j + 1 , n} = {P}_{j , n} + β \frac{{O}_{j , n}^{*} ( r - {R}_{n} )}{{\vert {O}_{j , n} ( r - {R}_{n} ) \vert}_{max}^{2}} ( {{ψ}^{′}}_{j , n} - {ψ}_{j , n} ) & Equation 9\end{matrix}$$

The parameters α and β adjust the update feedback. Exemplary values are α=1.0 and β=0.9. It should be noted that “*” in Equations 9 and 10 indicates the complex conjugate. Since intensity is being recovered, a non-negativity and realness constraint are added after the object and illumination updates. Those constraints are given by Equations 10 and 11 below:

O_{j+1,n}(r)=max(Re[O_{r+1,n}(r)],0) Equation 10:

P_{j+1,n}(r)=max(Re[P_{r+1,n}(r)],0) Equation 11:

In Equations 10 and 11, max(a,b) selects the maximum of a or b and Re[ ] selects the real part of a complex number. After the above algorithm cycles through all N scanning positions 204ᵢⱼ, one full iteration of ptychography is complete. Having described the modified version of ePIE, attention will now be directed to the inputs for that algorithm. ePIE requires 4 inputs: the diffraction patterns, the scanning positions, a guess of the object 110, and a guess of the illumination via the optical source 102. The diffraction patterns corresponding to each scanning position were obtained in S304. In an exemplary embodiment, those diffraction patterns may be binned or reduced in sized (e.g., using MATLAB's image resize function) by a factor of two before being fed into the ePIE algorithm. The scanning positions 204ᵢⱼ are known by controller 118 and are centered on zero by subtracting a central scanning position. The scanning positions 204ᵢⱼ are converted to pixel units by division of the image detector 116 pixel size. In the exemplary embodiment described above, the image detector 116 pixel size is 5.2 microns. The geometry of this exemplary setup (using the devices and values set forth above) results in a demagnification of M=0.282, which is applied to the scanning positions via multiplication. Subpixel shifting is employed within the algorithm. In an exemplary embodiment, the guess of the object is unity and the guess of the illumination is a circle with a diameter of 700 microns converted into demagnified pixel units. A blur of 10 pixels may be applied to the guess of the illumination using, for example, a motion blur function.

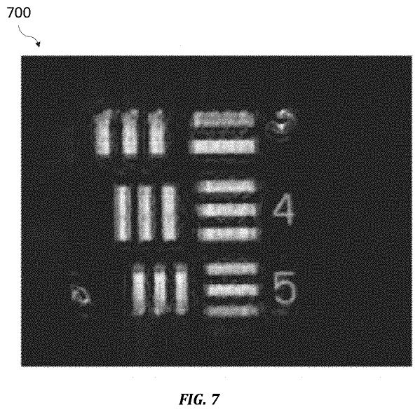

The modified version of the ePIE method described above may be run for a plurality of iterations to obtain a reconstructed image of the object 110. FIG. 7 shows a reconstructed image 700 obtained after 300 iterations. The first 100 iterations only update the object. Iterations 101-200 updated both the object and the probe. After 200 iterations, the object was reinitialized to unity, and the updated probe was used as the initial guess. By using the method illustrated in FIG. 3 and described above, it is possible to image a large object using incoherent scattered light.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method of imaging an incoherently illuminated object, comprising:
receiving image data recorded by an image detector,
wherein the image data comprises a plurality of images respectively corresponding to a plurality of scanning positions,
wherein each image is produced in response to the image detector receiving incoherent light that has passed through an object and then been diffused by a scattering layer;
generating a plurality of diffraction patterns respectively corresponding to the plurality of scanning positions from the image data; and
reconstructing an image of the object based on the plurality of diffraction patterns and the plurality of scanning positions.
